(19) United States
(12) Patent Application Publication
(10) Pub. No.: US 2025/0123886 A1
(43) Pub. Date: Apr. 17, 2025

(54) TASK PROCESSING METHOD AND APPARATUS, ELECTRONIC DEVICE, AND STORAGE MEDIUM

(71) Applicant: Beijing Youzhuju Network Technology Co., Ltd., Beijing (CN)

(72) Inventors: Qiusi WANG, Beijing (CN); Yi REN, Beijing (CN); Sai MA, Beijing (CN); Lei YOU, Beijing (CN); Weizhi LIU, Beijing (CN); Hongxiang SHU, Beijing (CN)

(21) Appl. No.: 18/999,754

(22) Filed: Dec. 23, 2024

(30) Foreign Application Priority Data
Jan. 29, 2024 (CN) 202410122586.2

(51) Int. Cl. G06F 9/48

(52) U.S. Cl. CPC G06F 9/4881

(57) ABSTRACT

Embodiments of the present disclosure provide a task processing method and apparatus, an electronic device, and a storage medium. The method includes: sending first notification information to a client of at least one task to be delivered that is associated with a current preset location, where the first notification information includes a wait time; receiving first feedback information from the at least one client, and determining a suspended task for deferred processing based on the first feedback information; and in response to receiving a task processing request sent by a target client corresponding to a target suspended task, determining a target processing manner corresponding to the target suspended task based on a current location, to process the target suspended task based on the target processing manner.

### CROSS-REFERENCE TO RELATED APPLICATION(S)

This application claims priority to Chinese Application No. 202410122586.2 filed on Jan. 29, 2024, the disclosure of which is incorporated herein by reference in its entity.

### FIELD

Embodiments of the present disclosure relate to the technical field of data processing, and in particular, to a task processing method and apparatus, an electronic device, and a storage medium.

### BACKGROUND

With the popularity of intelligence, more and more tasks can be performed by a robot. For example, the robot may be used in a building to perform document delivery, parcel delivery, food delivery, and other delivery tasks.

Generally, in order to improve the delivery efficiency of the robot, the robot may carry as many tasks to be delivered as possible. In the case of a large number of tasks to be delivered, each delivery may correspond to a plurality of users.

### SUMMARY

According to a first aspect, embodiments of the present disclosure provide a task processing method. The method is applied to a robot and includes:
sending first notification information to a client of at least one task to be delivered that is associated with a current preset location, wherein the first notification information comprises a wait time;
receiving first feedback information of the at least one client, and determining a suspended task for deferred processing based on the first feedback information; and
in response to receiving a task processing request sent by a target client corresponding to a target suspended task, determining a target processing manner corresponding to the target suspended task based on a current location, to process the target suspended task based on the target processing manner,
where the at least one client comprises the target client, and the suspended task comprises the target suspended task.

According to a second aspect, embodiments of the present disclosure further provide a task processing apparatus. The apparatus is configured in a robot and includes:
an information sending module configured to send first notification information to a client of at least one task to be delivered that is associated with a current preset location, wherein the first notification information comprises a wait time;
a suspended task determining module configured to receive first feedback information of the at least one client, and determine a suspended task for deferred processing based on the first feedback information; and
a processing manner determining module configured to, in response to receiving a task processing request sent by a target client corresponding to a target suspended task, determine a target processing manner corresponding to the target suspended task based on a current location, to process the target suspended task based on the target processing manner,
where the at least one client comprises the target client, and the suspended task comprises the target suspended task.

According to a third aspect, embodiments of the present disclosure further provide an electronic device. The electronic device includes:
one or more processors; and
a storage configured to store one or more programs, where
the one or more programs, when executed by the one or more processors, cause the one or more processors to implement the task processing method described in any of the embodiments of the present disclosure.

According to a fourth aspect, embodiments of the present disclosure further provide a storage medium comprising computer-executable instructions, where the computer-executable instructions, when executed by a computer processor, are configured to perform the task processing method described in any of the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a task processing method according to embodiments of the present disclosure;

FIG. 2 is a schematic flowchart of a task processing method according to embodiments of the present disclosure;

FIG. 3 is a schematic flowchart of a task processing method according to embodiments of the present disclosure;

FIG. 4 is a schematic diagram of a structure of a task processing apparatus according to embodiments of the present disclosure; and

FIG. 5 is a schematic diagram of a structure of an electronic device according to embodiments of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, notification information is sent to the user to clearly inform the user that a requested operation will require access to and use of the personal information of the user. As such, the user can independently choose, based on the notification information, whether to provide the personal information to software or hardware, such as an electronic device, an application, a server, or a storage medium, that performs operations in the technical solutions of the present disclosure.

As an optional but non-limiting implementation, in response to the reception of the active request from the user, the notification information may be sent to the user in the form of, for example, a pop-up window, in which the notification information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

Before the technical solutions provided in the embodiments of the present disclosure are described, an exemplary description may be given to the application scenario. The methods provided in the embodiments of the present disclosure may be integrated into a robot, such that the robot performs task processing based on the integrated methods. The robot may include a plurality of compartments. Each compartment may be used to accommodate a corresponding item, so that the robot can transport the item in the compartment to a corresponding user. For the robot, each item that needs to be transported to the user is a task to be processed. In this embodiment, a plurality of items in one compartment may be used as one task to be delivered, or each item may be used as one task to be delivered. The distinction for its specific tasks to be processed is not limited in this embodiment, as long as they are handled according to the content disclosed in this embodiment.

Further, in order to improve the delivery efficiency, one robot may usually comprise a plurality of tasks to be delivered. During a delivery process, there may be a plurality of delivery stations, at which the robot waits for the user to pick up the delivered item in the compartment. If the application scenario is inside a building, there may be a plurality of delivery stations on each floor. The robot may travel to the corresponding delivery station to deliver items.

As described above, the robot may carry as many delivery tasks as possible. In the case of a large number of delivery tasks, each delivery may correspond to a plurality of users. When there is a large number of users, the situation that a user is busy or is occupied with other things and thus cannot get to a delivery station in time to pick up a corresponding delivery task is prone to occur. Given that situation, the robot usually continues to perform subsequent delivery tasks, and does not deliver the task that is not picked up in time until all delivery tasks have been handled. In this case, there are problems of long wait time for users and low delivery efficiency.

The present disclosure provides a task processing method and apparatus, an electronic device, and a storage medium to achieve the effects of improving the efficiency of task processing and of improving user experience. According to the technical solution provided in the embodiments of the present disclosure, when the robot moves to the current preset location, the first notification information may be sent to the client corresponding to the at least one delivery task that is associated with the current preset location, so that the user corresponding to the client may be informed that the delivery task has arrived at the station and needs to be picked up in time. Further, if the user cannot pick up the corresponding delivery task in time, the information feedback may be made, so that the robot may determine whether to deliver other delivery tasks first based on the feedback information, and determine the delivery task that cannot be picked up in time as the suspended task. On the premise of continuing to deliver the other delivery tasks, if the request of continuing to deliver the suspended task that is initiated by the target client is received, how to process the suspended task is determined based on the current location of the robot and the location of the suspended task, which realizes the dynamic notification for the user to pick up the corresponding delivery task and the effective processing of the suspended task, thereby achieving the effect of enhancing the delivery efficiency and the user experience.

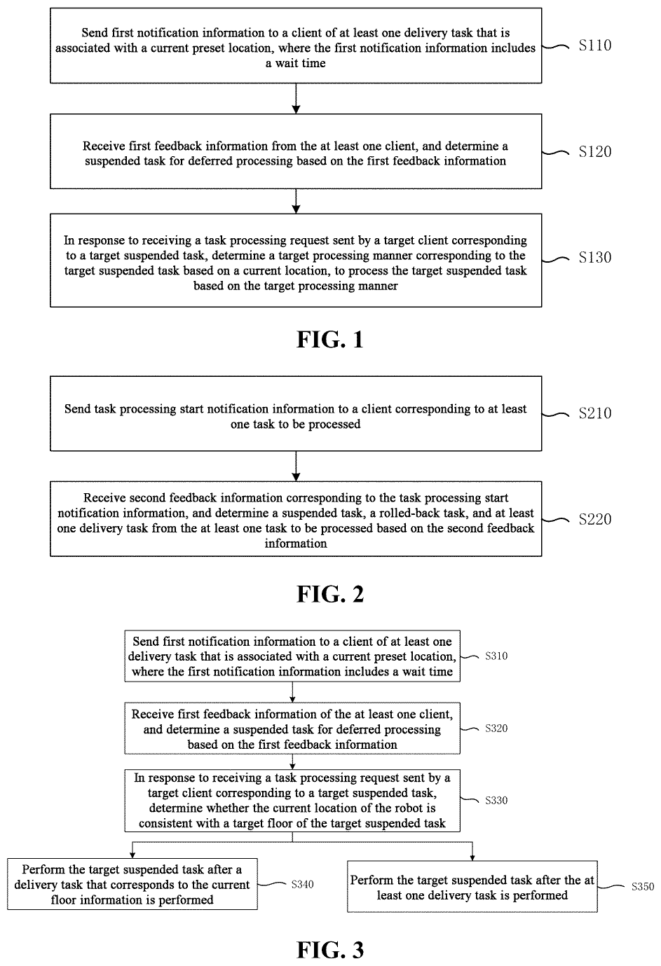

FIG. 1 is a schematic flowchart of a task processing method according to embodiments of the present disclosure. The embodiments of the present disclosure are applicable to a case that a task is handled based on a robot, and the method may be performed by a task processing apparatus. The apparatus may be implemented in the form of software and/or hardware. Optionally, the apparatus may be implemented by an electronic device, and the electronic device may be a mobile terminal, a PC, a server, or the like.

As shown in FIG. 1, the method includes the following steps.

S110: Send first notification information to a client of at least one task to be delivered that is associated with a current preset location, where the first notification information includes a wait time.

It should be noted that based on the above, it is known that there may be at least one delivery station, and each delivery station may be used as a preset location to which the robot is required to move. Operations performed after the robot moves to each of the preset locations are the same. Here, an operation to be performed after the robot moves to one of the preset locations is taken as an example to explain the solution provided in the embodiments of the present disclosure, where the preset location mentioned above is used as the current preset location.

It should also be noted that the robot carries at least one task to be delivered. The at least one task to be delivered corresponds to at least one user, who may be in different office locations inside a building. Distances of the different office locations to the preset location are also different. On this basis, a user associated with each preset location may be determined based on distance information on an office location of the user to the preset location. Accordingly, a client registered by the user is bound to the preset location.

There may be a plurality of tasks to be delivered that are associated with the current preset location. Notification information may be sent to a client used by a user of each task to be delivered, and the notification information may be used as the first notification information. In other words, the client mentioned here is a client used by the user corresponding to the task to be delivered. The first notification information may include that the robot has arrived at a station and how long the robot will wait at the station. Optionally, the wait time in the first notification information is 5 minutes, which may be displayed in a countdown manner on the client. That is, after the client receives the first notification information, the 5-minute time may be displayed on the client and then the countdown may start. In other words, the wait time is a total time for which the robot will wait at the current preset location.

Specifically, after the robot moves to one of the preset locations, the preset location to which the robot moves may be used as the current preset location. There may be a plurality of users who need to get to the current preset location to pick up a task to be delivered. It may be determined whether each user has a task to be delivered, and if it is determined that each user has a task to be delivered, first notification information is sent to a client of a corresponding user. After the client receives the first notification information, the user corresponding to the client may be certain that the robot has moved to the preset location, and needs to get to the preset location to pick up the task to be delivered. Meanwhile, in order for the user to pick up the task to be delivered in time, the wait time in the first notification information is displayed on the client in a countdown manner.

For example, after the robot has moved to a pickup point of the user (the current preset location), the first notification information may be sent to a client corresponding to at least one task to be delivered that is associated with the pickup point, that is, the first notification information includes a 5-minute wait time. Meanwhile, countdown information may be displayed on both the robot and the client.

On the basis of the above technical solution, after the first notification information is sent to the client, the countdown information may be displayed on the client and the robot, and when the countdown reaches a preset countdown threshold, notification information may be regenerated and sent to the client to achieve the effect of reminding the user again.

An accumulated wait time may be understood as a time for which the robot has been waiting at the current preset location. A preset wait time threshold is a preset time to determine whether to send the notification information again. The regenerated notification information may be understood as an update to the first notification information.

For example, when it is detected that the accumulated wait time of the robot at the current preset location reaches a preset wait time threshold of 4 minutes, the first notification information may be sent to the client, and in this case, the first notification information may include notification information that the robot will leave in 1 minute.

An advantage of the above method is that the notification information may be sent to the client again during the waiting process, so that the user can get to the current preset location in time to process the task to be delivered, thereby improving the user experience, and convenience and efficiency of the task processing.

In this embodiment, the method further includes: if the first feedback information includes wait extension information, updating a wait time of the robot at the current preset location based on the wait extension information, where the wait extension information includes a wait extension time and/or a number of wait extensions.

In practical application, if the user currently cannot pick up the item immediately and can only go to pick up the item after one or two minutes, a control corresponding to “Wait a minute” may be triggered, that is, the first feedback information may include content of wait extension information. Generally, in order to complete the task efficiently, the wait extension time in the wait extension information may be one minute or two minutes, and the number of wait extensions is usually only one. That is, if the user triggers a wait extension:

S120: Receive first feedback information from the at least one client, and determine a suspended task for deferred processing based on the first feedback information.

In practical application, the user may not be able to pick up the task to be delivered in time. In this case, the user may trigger a display control on the client to edit corresponding feedback information, and may feed the feedback information back to the robot by clicking feedback confirmation, and then the feedback information may be used as the first feedback information. The suspended task may be understood as a task that is temporarily left unhandled.

Specifically, after the first notification information is received by the at least one client, the user may determine whether to get to the current preset location to pick up the task to be delivered according to actual needs. If the user determines not to pick up the task to be delivered, then the user may trigger the display control on the client to edit the corresponding feedback information, or may trigger a “deferred processing” control. After the confirmation is clicked, the first feedback information may be generated and sent to the robot, enabling the robot to determine whether the task to be delivered is the suspended task based on the received first feedback information. If the first feedback information includes information that the task to be delivered is the suspended task, then the task to be delivered may be the suspended task.

S130: In response to receiving a task processing request sent by a target client corresponding to a target suspended task, determine a target processing manner corresponding to the target suspended task based on a current location, to process the target suspended task based on the target processing manner.

It should be noted that there may be a suspended task for each preset location.

In the case where the robot continues to deliver a task to be delivered and there is a suspended task, a task processing request sent by a client corresponding to the suspended task may be received, and the task processing request mainly corresponds to a request of processing the suspended task. The client that initiates the task processing request may be used as the target client, and accordingly, the suspended task corresponding to the target client may be used as the target suspended task. The target processing manner is a finally determined manner of processing the target suspended task, which is determined primarily in conjunction with a current location of the robot and a target location corresponding to the target suspended task.

Specifically, in the process of the robot processing the task to be delivered, if the task processing request initiated by the client to which the target suspended task belongs is received, the target processing manner for the target suspended task is determined based on the current location of the robot and the target location corresponding to the target suspended task, and then, the target suspended task is handled according to the target processing manner.

According to the technical solution provided in the embodiments of the present disclosure, when the robot moves to the current preset location, the first notification information may be sent to the client corresponding to the at least one task to be delivered that is associated with the current preset location, so that the user corresponding to the client may be informed that the task to be delivered has arrived at the station and needs to be picked up in time. Further, if the user cannot pick up the corresponding task to be delivered in time, the information feedback can be made, so that the robot can determine whether to deliver other tasks to be delivered first based on the feedback information, and use the task to be delivered that cannot be picked up in time as the suspended task. On the premise of continuing to deliver the other tasks to be delivered, if the request of continuing to deliver the suspended task that is initiated by the target client is received, how to process the suspended task is determined based on the current location of the robot and the location of the suspended task, which realizes the dynamic notification for the user to pick up the corresponding task to be delivered and the effective processing of the suspended task, thereby achieving the effect of enhancing the delivery efficiency and the user experience.

FIG. 2 is a schematic flowchart of a task processing method according to embodiments of the present disclosure. On the basis of the above embodiment, in order to further improve the processing efficiency for the task to be delivered and the user experience, task processing start notification information may be sent to clients corresponding to all tasks to be processed before the robot moves to each preset location, to determine the task to be delivered based on feedback information corresponding to the task processing start notification information. Details about technical terms that are the same as or corresponding to those in the above embodiments are not described herein again.

As shown in FIG. 2, the method includes the following steps.

S210: Send task processing start notification information to a client corresponding to at least one task to be processed.

At a target location, items that need to be transported by the robot in a current batch may be placed in corresponding compartments. All placed items are collectively referred as tasks to be processed. When the robot is ready to depart, the task processing start notification information may be sent to the clients corresponding to all tasks to be processed.

For example, at the time when the robot departs, notification information may be sent to a client corresponding to a task to be processed, and the notification information may be notification information for departure of the robot. The notification information may be used as the task processing start notification information.

S220: Receive second feedback information corresponding to the task processing start notification information, and determine a suspended task, a rolled-back task, and the at least one task to be delivered from the at least one task to be processed based on the second feedback information.

The feedback information corresponding to the processing start notification information may be used as the second feedback information. The second feedback information may include feedback information on whether to deliver the task and whether to delay the task delivery. If the second feedback information includes delivering the task at a later time, the task to be processed may be used as the suspended task. If the second feedback information includes not processing the task anymore, the task to be processed may be used as the rolled-back task. If the second feedback information is not received or the second feedback information is processing as normal, the task to be processed is a task to be delivered. In other words, the suspended task is a task that needs deferred processing, the rolled-back task is a task that will not be processed anymore on the same day, and the task to be delivered is a task that can be delivered immediately.

Specifically, the task processing start notification information may be sent to the client. Based on the notification information and their own circumstance, the client may determine whether it is necessary for the robot to process the task to be processed immediately. If it is necessary for the robot to process the task to be processed immediately, a display control on a display interface may not be triggered, or a “Deliver now” control on the client may be triggered, or a “Deliver later” control may be triggered. In this case, the delayed delivery mainly corresponds to delivery at a later time. Certainly, if the user cannot pick up the task to be processed in time, a “Do not deliver” control may be triggered, that is, no delivery is performed anymore on the same day, and a task to be processed that corresponds to this type may be used as the rolled-back task.

It should be noted that in order to improve the processing efficiency for the task to be processed, the rolled-back task may be placed at the target location after the rolled-back task is determined. The target location may be an initial location where the task to be processed is placed. An advantage of such setup is that in a case where it is determined that the user cannot pick up the task to be processed, the task can be temporarily stored at the target location, and if there is a need, a new task to be processed can be pulled for transportation, which improves the efficiency of task processing.

According to the technical solution provided in the embodiments of the present disclosure, the task processing start notification information may be sent to the client before the task to be processed is handled, so as to achieve the effect of notifying the corresponding user. Further, the task to be delivered and the suspended task among the tasks to be processed can be determined based on the feedback information from the client, so that the task to be delivered can be processed effectively, which achieves the effects of notifying the user in advance and performing effective task delivery.

On the basis of the above technical solution, determining the suspended task may be the following step: if the first feedback information includes deferred processing information, using a task to be delivered that corresponds to the first feedback information as the suspended task; or, if second feedback information includes deferred processing information, using a task to be processed corresponding to the second feedback information as the suspended task.

It may be understood as: When the client corresponding to the task to be delivered receives the first notification information and/or the second notification information, display controls including “Pick up now”, “Pick up later”, and “Wait for me for a moment” may be popped up on the display interface. If the user cannot arrive at the current preset location for pickup in time and requires deferred processing, a “Pick up later” control may be triggered. In this case, either the first feedback information or the second feedback information may be generated based on the triggered control. That is, the deferred processing information is information generated after the “Pick up later” control is triggered. The suspended task is a task that needs deferred processing.

When the above manner is used to process the task to be delivered, the task to be delivered can be delivered effectively, thereby avoiding the problem of poor usage experience caused by long wait time for the user or for the robot.

FIG. 3 is a schematic flowchart of a task processing method provided in embodiments of the present disclosure. On the basis of the above embodiment, when the task processing request sent by the target client to which the target suspended task belongs is received, the target processing manner for the target suspended task may be determined based on the current location of the robot and the location of the target suspended task, so that the task is handled according to the target processing manner. For the specific implementation thereof, reference may be made to the detailed description of this technical solution, where details about technical terms that are the same as or corresponding to those in the above embodiments are not described herein again.

As shown in FIG. 3, the method includes the following steps.

S310: Send first notification information to a client of at least one task to be delivered that is associated with a current preset location, where the first notification information includes a wait time.

S320: Receive first feedback information from the at least one client, and determine a suspended task for deferred processing based on the first feedback information.

S330: In response to receiving a task processing request sent by a target client corresponding to a target suspended task, determine whether the current location of the robot is consistent with a target floor of the target suspended task, and if they are consistent, perform S340; and if they are not consistent, perform S350.

In practical application, if the user has time to process the suspended task, a preset control on the client may be triggered, and optionally, the preset control may be a control for delivering a suspended task. The task processing request is generated based on a trigger operation for the preset control by the user and sent to the robot. After receiving the task processing request, the robot may determine the target processing manner for the target suspended task based on the current location of the robot and the target location of the target suspended task.

The technical solution provided in the embodiments of the present disclosure may be applied to a building, and if applied to a building, the current location of the robot may be a current floor.

Specifically, it may be determined whether the current floor of the robot and the target floor of the target suspended task are the same, and if they are the same, S340 may be performed, and if they are not the same floor:
S340: Perform the target suspended task after a task to be delivered that corresponds to the current floor information is performed.

It can be understood in this way: the robot is on the current floor, and at this time, in order to improve the delivery efficiency, it may first complete the task to be delivered on the current floor and then continue to deliver the target suspended task. An advantage of such setup is that not only can the task to be delivered be efficiently delivered, but also the time that the user waits for delivery, thereby achieving the technical effect of improving the user experience.

S350: Perform the target suspended task after the at least one task to be delivered is performed.

It may be understood in this way: if the robot and the target suspended task are not on the same floor, in order to improve the delivery efficiency, the robot may complete the task to be delivered first and then go to the target floor to deliver the target suspended task.

It should be further noted that in order to further improve the efficiency of task processing, it is possible to determine how to process the target suspended task based on the current location of the robot and the target location corresponding to the target suspended task, which greatly improves the efficiency of processing the target suspended task and the task to be delivered.

According to the technical solution provided in the embodiments of the present disclosure, in the process of delivering the task to be delivered, if the task processing request corresponding to the suspended task is received, the processing manner for the suspended task can be comprehensively determined based on the location information corresponding to the suspended task and the location information of the robot, thereby reducing the wait time of the user and achieving the effect of improving the task delivery efficiency.

On the basis of the above technical solution, if temporary storage information corresponding to the suspended task is received, the suspended task is marked, so as to temporarily store the suspended task at a target location based on the mark.

The temporary storage information may be understood as information on temporarily storing the suspended task at the target location. The target location may be a preset location at which the suspended task is placed. Generally, there are a large number of tasks to be processed and a limited number of suspended tasks, and it is difficult to identify a suspended task from the tasks to be processed. Therefore, the suspended task may be placed in a special area so that the user can quickly find the suspended task from the target location, thereby improving the convenience of finding the suspended task.

Specifically, the user may trigger a “Select task temporary storage” control on the client, and the temporary information may be generated based on the trigger operation for the control and sent to the robot. After the temporary storage information is received by the robot, the corresponding suspended task may be marked. The suspended task may be temporarily placed at the target location based on the mark.

Based on the above technical solution, the method further includes: receiving task rollback information sent by a target management terminal, where the task rollback information includes at least one suspended task that is unhandled within a preset time; and placing the at least one suspended task at a target location.

In practical application, the robot can not only receive the feedback information and the task processing request that are sent by a user side (the client), but also receive a message sent by a management side. The management side corresponds to a side that manages all tasks to be delivered. Optionally, the management side may be a terminal device used by a management user corresponding to the robot.

Specifically, when one or more suspended tasks have not been handled for a long time, it may be the case that there is no way to process the tasks for a long time, or a working time of the robot reaches a preset time threshold, or the current time has exceeded a task processing time range. In those cases, the management side may send the task rollback information to the robot. The task rollback information may include information on at least one suspended task that is unhandled within a preset time. After the task rollback information is received by the robot, the at least one suspended task may be transported to the target location. The target location may be a location at which the task to be delivered is temporarily stored, or a location at which all tasks to be processed are placed, or a preset location at which the suspended task is placed. That is, the target location may be a preset location at which the suspended task is placed. An advantage of such setup is that the number of suspended tasks is generally limited, so that the user can quickly identify their suspended task from the target location, which improves the efficiency of task processing.

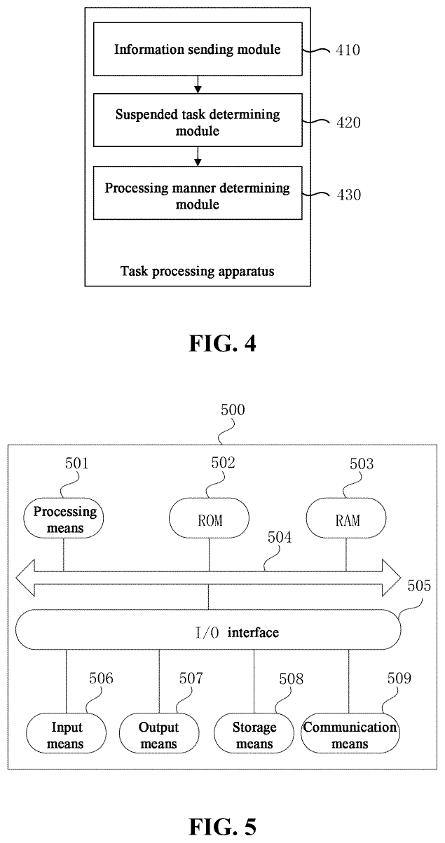

FIG. 4 is a schematic diagram of a structure of a task processing apparatus according to embodiments of the present disclosure. As shown in FIG. 4, the apparatus includes: an information sending module 410, a suspended task determining module 420, and a processing manner determining module 430.

The information sending module 410 is configured to send first notification information to a client of at least one task to be delivered that is associated with a current preset location, where the first notification information includes a wait time; the suspended task determining module 420 is configured to receive first feedback information from the at least one client, and determine a suspended task for deferred processing based on the first feedback information; and the processing manner determining module 430 is configured to, in response to receiving a task processing request sent by a target client corresponding to a target suspended task, determine a target processing manner corresponding to the target suspended task based on a current location, to process the target suspended task based on the target processing manner, where the at least one client includes the target client, and the suspended task includes the target suspended task.

On the basis of the above technical solutions, the apparatus further includes:
a notification information sending module configured to send task processing start notification information to a client corresponding to at least one task to be processed, where the at least one task to be processed is a task among tasks currently performed by the robot, the at least one task to be processed includes the at least one task to be delivered, and the task to be processed corresponds to different preset locations; and a task to be delivered determining module configured to receive second feedback information corresponding to the task processing start notification information, and determine a suspended task and the at least one task to be delivered from the at least one task to be processed based on the second feedback information.

On the basis of the above technical solutions, the apparatus further includes:
a notification information updating module configured to detect an accumulated wait time at the current preset location, and update the first notification information in response to the accumulated wait time reaching a preset wait time threshold.

On the basis of the above technical solutions, the suspended task determining module is further configured to:
in response to the first feedback information comprising deferred processing information, determine a task to be delivered corresponding to the first feedback information as the suspended task; or in response to second feedback information comprising the deferred processing information, determine a task to be processed corresponding to the second feedback information as the suspended task.

On the basis of the above technical solutions, the apparatus further includes:
a wait time determining module configured to, in response to the first feedback information comprising wait extension information, update the wait time of the robot at the current preset location based on the wait extension information,
where the wait extension information comprises a wait extension time and/or a number of wait extensions.

On the basis of the above technical solutions, the current location includes current floor information, and the processing manner determining module includes:
a first processing unit configured to, in response to the current floor information being consistent with target floor information of the target suspended task, the target processing manner is performing the target suspended task after a task to be delivered that corresponds to the current floor information is performed; and
a second processing unit configured to, in response to the current floor information being not consistent with the target floor information of the target suspended task, the target processing manner is performing the target suspended task after the at least one task to be delivered is performed.

On the basis of the above technical solutions, the apparatus further includes: a temporary storage module configured to, if temporary storage information corresponding to the suspended task is received, mark the suspended task to temporarily store the suspended task at a target location based on the mark.

On the basis of the above technical solutions, the apparatus further includes:
a returning information receiving module configured to receive task rollback information sent by a target management terminal, where the task rollback information comprises task information of at least one suspended task; and
a placement module configured to place the at least one suspended task at a target location.

According to the technical solution provided in the embodiments of the present disclosure, when the robot moves to the current preset location, the first notification information may be sent to the client corresponding to the at least one task to be delivered that is associated with the current preset location, so that the user corresponding to the client may be informed that the task to be delivered has arrived at the station and needs to be picked up in time. Further, if the user cannot pick up the corresponding task to be delivered in time, the information feedback can be made, so that the robot can determine whether to deliver other tasks to be delivered first based on the feedback information, and use the task to be delivered that cannot be picked up in time as the suspended task. On the premise of continuing to deliver the other tasks to be delivered, if the request of continuing to deliver the suspended task that is initiated by the target client is received, how to process the suspended task is determined based on the current location of the robot and the location of the suspended task, which realizes the dynamic notification for the user to pick up the corresponding task to be delivered and the effective processing of the suspended task, thereby achieving the effect of enhancing the delivery efficiency and the user experience.

The task processing apparatus according to embodiments of the present disclosure can perform the task processing method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 5 is a schematic diagram of a structure of an electronic device according to embodiments of the present disclosure. Reference is made to FIG. 5 below, which is a schematic diagram of a structure of an electronic device (such as a terminal device or a server in FIG. 5) 500 suitable for implementing embodiments of the present disclosure. The terminal device in the embodiments of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing means (e.g., a central processing unit or a graphics processing unit) 501 that may perform a variety of appropriate actions and processing in accordance with a program stored in a read-only memory (ROM) 502 or a program loaded from a storage means 508 into a random access memory (RAM) 503. The RAM 503 further stores various programs and data required for the operation of the electronic device 500. The processing means 501, the ROM 502, and the RAM 503 are connected to each other through a bus 504. An input/output (I/O) interface 505 is also connected to the bus 504.

Generally, the following apparatuses may be connected to the I/O interface 505: an input means 506 including, for example, a touchscreen, a touchpad, a keyboard, a mouse, a camera, a microphone, an accelerometer, and a gyroscope; an output means 507 including, for example, a liquid crystal display (LCD), a speaker, and a vibrator; the storage means 508 including, for example, a tape and a hard disk; and a communication means 509. The communication means 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded from a network through the communication means 509 and installed, installed from the storage means 508, or installed from the ROM 502. When the computer program is executed by the processing means 501, the above-mentioned functions defined in the method of the embodiments of the present disclosure are performed.

The names of messages or information exchanged between a plurality of apparatuses in the implementations of the present disclosure are used for illustrative purposes only, and are not used to limit the scope of these messages or information.

The electronic device according to embodiments of the present disclosure and the task processing method according to the above embodiments belong to the same inventive concept. For the technical details not exhaustively described in this embodiment, reference may be made to the above embodiments, and these embodiments and the above embodiments have the same beneficial effects.

Embodiments of the present disclosure provide a computer storage medium storing a computer program thereon, where the program, when executed by a processor, implements the task processing method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
send first notification information to a client of at least one task to be delivered that is associated with a current preset location, where the first notification information comprises a wait time;
receive first feedback information of the at least one client, and determining a suspended task for deferred processing based on the first feedback information; and
in response to receiving a task processing request sent by a target client corresponding to a target suspended task, determine a target processing manner corresponding to the target suspended task based on a current location, to process the target suspended task based on the target processing manner,
where the at least one client comprises the target client, and the suspended task comprises the target suspended task.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a task processing method. The method is applied to a robot and includes:
sending first notification information to a client of at least one task to be delivered that is associated with a current preset location, where the first notification information comprises a wait time;
receiving first feedback information of the at least one client, and determining a suspended task for deferred processing based on the first feedback information; and
in response to receiving a task processing request sent by a target client corresponding to a target suspended task, determining a target processing manner corresponding to the target suspended task based on a current location, to process the target suspended task based on the target processing manner,
where the at least one client comprises the target client, and the suspended task comprises the target suspended task.

According to one or more embodiments of the present disclosure, [Example 2] provides a task processing method. The method further includes:
optionally, sending task processing start notification information to a client corresponding to at least one task to be processed, where the at least one task to be processed is a task among tasks currently performed by the robot, the at least one task to be processed comprises the at least one task to be delivered, and the at least one task to be processed corresponds to different preset locations; and
receiving second feedback information corresponding to the task processing start notification information, and determining a suspended task, a rolled-back task, and the at least one task to be delivered from the at least one task to be processed based on the second feedback information.

According to one or more embodiments of the present disclosure, [Example 3] provides a task processing method. The method further includes:
optionally, detecting an accumulated wait time at the current preset location, and updating the first notification information in response to the accumulated wait time reaching a preset wait time threshold.

According to one or more embodiments of the present disclosure, [Example 4] provides a task processing method. The method further includes:
optionally, the determining a suspended task includes:
in response to the first feedback information comprising deferred processing information, determining a task to be delivered corresponding to the first feedback information as the suspended task; or
in response to second feedback information comprising the deferred processing information, determining a task to be processed corresponding to the second feedback information as the suspended task.

According to one or more embodiments of the present disclosure, [Example 5] provides a task processing method. The method further includes:
optionally, in response to the first feedback information comprising wait extension information, updating the wait time of the robot at the current preset location based on the wait extension information,
where the wait extension information comprises a wait extension time and/or a number of wait extensions.

According to one or more embodiments of the present disclosure, [Example 6] provides a task processing method. The method further includes:
optionally, the current location includes current floor information, and determining the target processing manner corresponding to the target suspended task based on the current location includes:
in response to the current floor information being consistent with target floor information of the target suspended task, determining the target processing manner as performing the target suspended task after a task to be delivered that corresponds to the current floor information is performed; or
in response to the current floor information being not consistent with the target floor information of the target suspended task, determining the target processing manner as performing the target suspended task after the at least one task to be delivered is performed.

According to one or more embodiments of the present disclosure, [Example 7] provides a task processing method. The method further includes:
optionally, in response to receiving temporary storage information corresponding to the suspended task, marking the suspended task to temporarily store the suspended task at a target location based on the mark.

According to one or more embodiments of the present disclosure, [Example 8] provides a task processing method. The method further includes:
optionally, receiving task rollback information sent by a target management terminal, where the task rollback information comprises task information of at least one suspended task; and
placing the at least one suspended task at a target location.

According to one or more embodiments of the present disclosure, [Example 9] provides a task processing apparatus. The apparatus is configured in a robot and includes:
an information sending module configured to send first notification information to a client of at least one task to be delivered that is associated with a current preset location, where the first notification information comprises a wait time;
a suspended task determining module configured to receive first feedback information of the at least one client, and determine a suspended task for deferred processing based on the first feedback information; and
a processing manner determining module configured to, in response to receiving a task processing request sent by a target client corresponding to a target suspended task, determine a target processing manner corresponding to the target suspended task based on a current location, to process the target suspended task based on the target processing manner,
where the at least one client comprises the target client, and the suspended task comprises the target suspended task.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A task processing method, wherein the method is applied to a robot, and the method comprises:
sending first notification information to a client of at least one task to be delivered that is associated with a current preset location, wherein the first notification information comprises a wait time;
receiving first feedback information of the at least one client, and determining a suspended task for deferred processing based on the first feedback information; and
in response to receiving a task processing request sent by a target client corresponding to a target suspended task, determining a target processing manner corresponding to the target suspended task based on a current location, to process the target suspended task based on the target processing manner,
wherein the at least one client comprises the target client, and the suspended task comprises the target suspended task.

2. The method according to claim 1, further comprising:
sending task processing start notification information to a client corresponding to at least one task to be processed, wherein the at least one task to be processed is a task among tasks currently performed by the robot, the at least one task to be processed comprises the at least one task to be delivered, and the at least one task to be processed corresponds to different preset locations; and
receiving second feedback information corresponding to the task processing start notification information, and determining a suspended task, a rolled-back task, and the at least one task to be delivered from the at least one task to be processed based on the second feedback information,
wherein the rolled-back task is a task that is placed at a target location.

3. The method according to claim 1, further comprising:
detecting an accumulated wait time at the current preset location, and updating the first notification information in response to the accumulated wait time reaching a preset wait time threshold.

4. The method according to claim 1, wherein determining the suspended task comprises:
in response to the first feedback information comprising deferred processing information, determining a task to be delivered corresponding to the first feedback information as the suspended task; or
in response to second feedback information comprising the deferred processing information, determining a task to be processed corresponding to the second feedback information as the suspended task.

5. The method according to claim 1, further comprising:
in response to the first feedback information comprising wait extension information, updating the wait time of the robot at the current preset location based on the wait extension information,
wherein the wait extension information comprises a wait extension time and/or a number of wait extensions.

6. The method according to claim 1, wherein the current location comprises current floor information, and determining the target processing manner corresponding to the target suspended task based on the current location comprises:
in response to the current floor information being consistent with target floor information of the target suspended task, determining the target processing manner as performing the target suspended task after a task to be delivered that corresponds to the current floor information is performed; or
in response to the current floor information being not consistent with the target floor information of the target suspended task, determining the target processing manner as performing the target suspended task after the at least one task to be delivered is performed.

7. The method according to claim 1, further comprising:
in response to receiving temporary storage information corresponding to the suspended task, marking the suspended task to temporarily store the suspended task at a target location based on the mark.

8. The method according to claim 1, further comprising:
receiving task rollback information sent by a target management terminal, wherein the task rollback information comprises task information of at least one suspended task; and
placing the at least one suspended task at a target location.

9. An electronic device, comprising:
one or more processors; and
a storage configured to store one or more programs, wherein
the one or more programs, when executed by the one or more processors, cause the one or more processors to:
send first notification information to a client of at least one delivery task that is associated with a current preset location, wherein the first notification information comprises a wait time;
receive first feedback information of the at least one client, and determine a suspended task for deferred processing based on the first feedback information; and
in response to receiving a task processing request sent by a target client corresponding to a target suspended task, determine a target processing manner corresponding to the target suspended task based on a current location, to process the target suspended task based on the target processing manner,
wherein the at least one client comprises the target client, and the suspended task comprises the target suspended task.

10. The device according to claim 9, wherein the one or more programs further cause the one or more processors to:
send task processing start notification information to a client corresponding to at least one task to be processed, wherein the at least one task to be processed is a task among tasks currently performed by the robot, the at least one task to be processed comprises the at least one delivery task, and the at least one task to be processed corresponds to different preset locations; and
receive second feedback information corresponding to the task processing start notification information, and determine a suspended task, a rolled-back task, and the at least one delivery task from the at least one task to be processed based on the second feedback information,
wherein the rolled-back task is a task that is placed at a target location.

11. The device according to claim 9, wherein the one or more programs further cause the one or more processors to:
detect an accumulated wait time at the current preset location, and update the first notification information in response to the accumulated wait time reaching a preset wait time threshold.

12. The device according to claim 9, wherein the one or more programs causing the one or more processors to determine the suspended task further cause the one or more processors to:
in response to the first feedback information comprising deferred processing information, determine a delivery task corresponding to the first feedback information as the suspended task; or
in response to second feedback information comprising the deferred processing information, determine a task to be processed corresponding to the second feedback information as the suspended task.

13. The device according to claim 9, wherein the one or more programs further cause the one or more processors to:
in response to the first feedback information comprising wait extension information, update the wait time of the robot at the current preset location based on the wait extension information,
wherein the wait extension information comprises a wait extension time and/or a number of wait extensions.

14. The device according to claim 9, wherein the current location comprises current floor information, and the one or more programs causing the one or more processors to determine the target processing manner corresponding to the target suspended task based on the current location further cause the one or more processors to:
in response to the current floor information being consistent with target floor information of the target suspended task, determine the target processing manner as performing the target suspended task after a delivery task that corresponds to the current floor information is performed; or
in response to the current floor information being not consistent with the target floor information of the target suspended task, determine the target processing manner as performing the target suspended task after the at least one delivery task is performed.

15. The device according to claim 9, wherein the one or more programs further cause the one or more processors to:
in response to receiving temporary storage information corresponding to the suspended task, mark the suspended task to temporarily store the suspended task at a target location based on the mark.

16. The device according to claim 9, wherein the one or more programs further cause the one or more processors to:
receive task rollback information sent by a target management terminal, wherein the task rollback information comprises task information of at least one suspended task; and
place the at least one suspended task at a target location.

17. A non-transitory storage medium comprising computer-executable instructions, wherein the computer-executable instructions, when executed by a computer processor, cause a computer to:
send first notification information to a client of at least one delivery task that is associated with a current preset location, wherein the first notification information comprises a wait time;
receive first feedback information of the at least one client, and determine a suspended task for deferred processing based on the first feedback information; and
in response to receiving a task processing request sent by a target client corresponding to a target suspended task, determine a target processing manner corresponding to the target suspended task based on a current location, to process the target suspended task based on the target processing manner,
wherein the at least one client comprises the target client, and the suspended task comprises the target suspended task.

18. The medium according to claim 17, wherein the instructions further cause the computer to:
send task processing start notification information to a client corresponding to at least one task to be processed, wherein the at least one task to be processed is a task among tasks currently performed by the robot, the at least one task to be processed comprises the at least one delivery task, and the at least one task to be processed corresponds to different preset locations; and
receive second feedback information corresponding to the task processing start notification information, and determine a suspended task, a rolled-back task, and the at least one delivery task from the at least one task to be processed based on the second feedback information,
wherein the rolled-back task is a task that is placed at a target location.

19. The medium according to claim 17, wherein the instructions further cause the computer to:
detect an accumulated wait time at the current preset location, and update the first notification information in response to the accumulated wait time reaching a preset wait time threshold.

20. The medium according to claim 17, wherein the instructions causing the computer to determine the suspended task further cause the computer to:
in response to the first feedback information comprising deferred processing information, determine a delivery task corresponding to the first feedback information as the suspended task; or
in response to second feedback information comprising the deferred processing information, determine a task to be processed corresponding to the second feedback information as the suspended task.
